(19) United States
(12) Patent Application Publication
(10) Pub. No.: US 2016/0291704 A1
(43) Pub. Date: Oct. 6, 2016

(54) DISAMBIGUATION OF STYLI BY CORRELATING ACCELERATION ON TOUCH INPUTS

(71) Applicant: UNIVERSITY OF NEWCASTLE UPON TYNE, Newcastle upon Tyne, Tyne and wear (GB)

(72) Inventors: Dan Jackson, Newcastle upon Tyne, Tyne and Wear (GB); Patrick Oliver, Newcastle upon Tyne, Tyne and Wear (GB); Ahmed Kharrufa, Newcastle upon Tyne, Tyne and Wear (GB); Nils Hammerla, Newcastle upon Tyne, Tyne and Wear (GB)

(73) Assignee: University of Newcastle Upon Tyne, Newcastle upon Tyne, Tyne and Wear (UK)

(21) Appl. No.: 15/035,178

(22) PCT Filed: Nov. 7, 2014
(86) PCT No.: PCT/GB2014/053327

§ 371 Date: May 6, 2016

(30) Foreign Application Priority Data
Nov. 8, 2013 (GB) 1319778.5

(51) Int. Cl. G06F 3/038; G06F 21/36; G06F 3/0346; G06F 3/0354; G06F 3/01; G06F 3/041

(52) U.S. Cl. CPC G06F 3/0383; G06F 3/014; G06F 3/0416; G06F 3/0346; G06F 3/03545; G06F 21/36; G06F 2221/2103

(57) ABSTRACT

A method for processing an input applied by an input object is provided. The method comprises the steps of receiving, from a motion unit, motion data comprising information indicating motion of the motion unit, wherein the motion unit is arranged to co-move with the input object; receiving, from the motion unit, identification information for identifying the motion unit; receiving input data, wherein the input data comprises information indicating characteristics of one or more inputs applied to an input unit; comparing the motion data with the input data; and outputting a signal for controlling processing of the inputs depending on a result of the comparison, and according to the identification information.

### BACKGROUND OF THE INVENTION

1. Field of the invention

The present invention relates generally to a technique for identifying a user or input object applying an input (e.g. a touch input or a proximity input). For example, certain exemplary embodiments of the present invention provide a method, apparatus and/or system for determining that a certain user who is wearing a motion sensor has applied a certain touch or proximity input to a touch sensitive device.

2. Description of the Related Art

Touch sensitive devices are becoming increasingly common and popular. For example, various types of device, including mobile telephones, tablet computers, and laptop computers, are typically provided with a touch sensitive input unit, for example in the form of a touch panel or touch screen. As the popularity of touch sensitive devices increases, there is a greater demand for enhanced interactivity between users and their devices.

One way to enhance interactivity with touch sensitive devices is to process touch inputs differently according to the identity of a user who has applied the input. Processing touch inputs according to user identity may allow multiple users to individually interact with the same touch sensitive device. For example, it may be useful to allow a teacher and a student to simultaneously interact with the same device providing an educational application. Processing touch inputs according to user identity may also allow a restriction to be placed on which users are allowed to use a device, or perform certain operations of a device. For example, it may be useful to allow only an authorised user to unlock a locked device by applying a certain touch gesture, or to only allow an administrator or a teacher to perform certain operations on a device.

In order for a device to process touch inputs according to the identity of a user who has applied the input, it is necessary for the device to be able to determine which user has applied each input. Various techniques have been developed for this purpose.

For example, one technique for allowing multiple users to simultaneously interact with a touch sensitive device is known as DiamondTouch. According to this technique, an array of insulated antennas, each transmitting a mutually orthogonal signal, is embedded within a touch surface. The users sit on chairs, each comprising a respective receiver unit that is connected back to the transmitters through a shared electrical ground reference. When a certain user touches the touch surface, signals from one or more antennas located beneath the touch point are capacitively coupled through the user and into the receiver unit associated with that user, making it possible to identify the user who touched the surface. Thus, a capacitively coupled circuit is completed, and by measuring the circuit capacitance, it is possible to determine the position of the identified user's touch.

A number of further techniques utilize external equipment such as external cameras and computer vision techniques for extracting biometric information to identify users, or for hand tracking.

Another technique is based on using Infra-Red (IR) pulsating wrist-bands for determining hand orientation for helping user identification. In more detail, each wrist-band transmits a respective unique code, allowing a specific wristband to be associated with each touch registered in an area near a detected IR pattern. Moreover, by utilizing two Light Emitting Diodes (LEDs) using a specific blinking pattern, it is possible to determine a wristband's orientation, and thereby narrow down the area of finger touch association based on the estimated location of the hand (and consequently fingers).

Yet a further technique uses a ring-like device transmitting a continuous pseudorandom IR pulse sequence. Each sequence is associated with a particular user and all touches in direct vicinity of the detected sequence are associated with that user.

Existing techniques suffer various problems. For example, some techniques can only be used in conjunction with devices incorporating special or dedicated technology that may not be available in many types of device. Furthermore, some techniques rely on external equipment that is relatively expensive, or may require systems that are complex and difficult to set-up. In addition, some techniques make certain assumptions about the positions of users around a device, and are therefore inflexible and overly restrictive.

Accordingly, what is desired is an technique for identifying a user or input object applying an input (e.g. a touch input or a proximity input) that utilizes relatively low-cost technology, is easy to set up, is technology independent, may be used with a wide variety of devices with relatively little or no modifications required, and/or is flexible in use-scenarios.

### SUMMARY OF THE INVENTION

It is an aim of certain exemplary embodiments of the present invention to address, solve and/or mitigate, at least partly, at least one of the problems and/or disadvantages associated with the related art, for example at least one of the problems and/or disadvantages described above. It is an aim of certain exemplary embodiments of the present invention to provide at least one advantage over the related art, for example at least one of the advantages described below.

The present invention is defined by the independent claims. Advantageous features are defined by the dependent claims.

In accordance with an aspect of the present invention, there is provided a method according to any one of claims 1 to 18.

In accordance with another aspect of the present invention, there is provided an apparatus according to any one of claims 19 to 35 and 40.

In accordance with other aspects of the present invention, there is provided a user device according to claim 36, a server according to claim 37, and/or a system according to claim 38 or 39.

In accordance with another aspect of the present invention, there is provided a method for identifying an input object applying an input, the method comprising the steps of: receiving, from a motion unit, motion data comprising information indicating motion of the motion unit, wherein the motion unit is arranged to co-move with the input object; receiving input data, wherein the input data comprises information indicating characteristics of one or more inputs applied to an input unit; comparing the motion data with the input data; and determining that the inputs were applied to the input unit by the input object, depending on a result of the comparison.

In accordance with another aspect of the present invention, there is provided an apparatus for identifying an input object applying an input, the apparatus comprising: a receiver for receiving, from a motion unit, motion data comprising information indicating motion of the motion unit, and for receiving input data, wherein the motion unit is arranged to co-move with the input object, wherein the input data is based on the output of an input unit, and wherein the input data comprises information indicating characteristics of one or more inputs applied to the input unit; and a processor for comparing the motion data with the input data, and for determining that the inputs were applied to the input unit by the input object, depending on a result of the comparison.

In accordance with another aspect of the system comprising: an apparatus according to any of the above aspects; and the motion unit, wherein the motion unit comprises a motion sensor for measuring motion of the motion unit, and a transmitter for transmitting the motion data, wherein the motion data is generated by the motion unit based on the measured motion of the motion unit.

In accordance with another aspect of the present invention, there is provided a computer program comprising instructions arranged, when executed, to implement a method, apparatus and/or system in accordance with any aspect or claim disclosed herein.

In accordance with another aspect of the present invention, there is provided a machine-readable storage storing a computer program according to the preceding aspect.

Other aspects, advantages, and salient features of the present invention will become apparent to those skilled in the art from the following detailed description, which, taken in conjunction with the annexed drawings, disclose exemplary embodiments of the present invention.

### BRIEF DESCRIPTION OF THE DRAWINGS

The above and other aspects, and features and advantages of certain exemplary embodiments and aspects of the present invention will be more apparent from the following detailed description, when taken in conjunction with the accompanying drawings, in which:

FIG. 1 illustrates a first exemplary system embodying the present invention;

FIGS. 2a-f illustrate an example of an input applied by a user, input data and motion data resulting from the input, and motion data unrelated to the input;

FIG. 3 illustrates a second exemplary system embodying the present invention;

FIG. 4 illustrates a third exemplary system embodying the present invention;

FIG. 5 illustrates a fourth exemplary system embodying the present invention;

FIG. 6 illustrates a fifth exemplary system embodying the present invention;

FIGS. 7a-c illustrates an exemplary input challenge; and

FIG. 8 illustrates a method according to an exemplary embodiment of the present invention.

### DETAILED DESCRIPTION OF EXEMPLARY EMBODIMENTS

The following description of exemplary embodiments of the present invention, with reference to the accompanying drawings, is provided to assist in a comprehensive understanding of the present invention. The description includes various specific details to assist in that understanding but these are to be regarded as merely exemplary. Accordingly, those of ordinary skill in the art will recognize that various changes and modifications of the embodiments described herein can be made without departing from the scope of the present invention, as defined by the claims.

The terms, words and phrases used in the following description and claims are not limited to the bibliographical meanings, but, are used to enable a clear and consistent understanding of the present invention.

In the description and figures of this specification, the same or similar features may be designated by the same or similar reference numerals, although they may be illustrated in different drawings.

Detailed descriptions of structures, constructions, functions or processes known in the art may be omitted for clarity and conciseness, and to avoid obscuring the subject matter of the present invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, characteristics, properties and/or groups thereof.

Throughout the description and claims of this specification, the singular forms “a,” “an,” and “the” include plural referents unless the context dictates otherwise. Thus, for example, reference to “an object” includes reference to one or more of such objects.

Throughout the description and claims of this specification, language in the general form of “X for Y” (where Y is some action, process, activity, operation or step and X is some means for carrying out that action, process, activity, operation or step) encompasses means X adapted, configured or arranged specifically, but not exclusively, to do Y.

Features, elements, components, integers, steps, processes, operations, functions, characteristics, properties and/or groups thereof described in conjunction with a particular aspect, embodiment or example of the present invention are to be understood to be applicable to any other aspect, embodiment or example described herein, unless incompatible therewith.

The methods described herein may be implemented in any suitably arranged apparatus or system comprising means for carrying out the method steps.

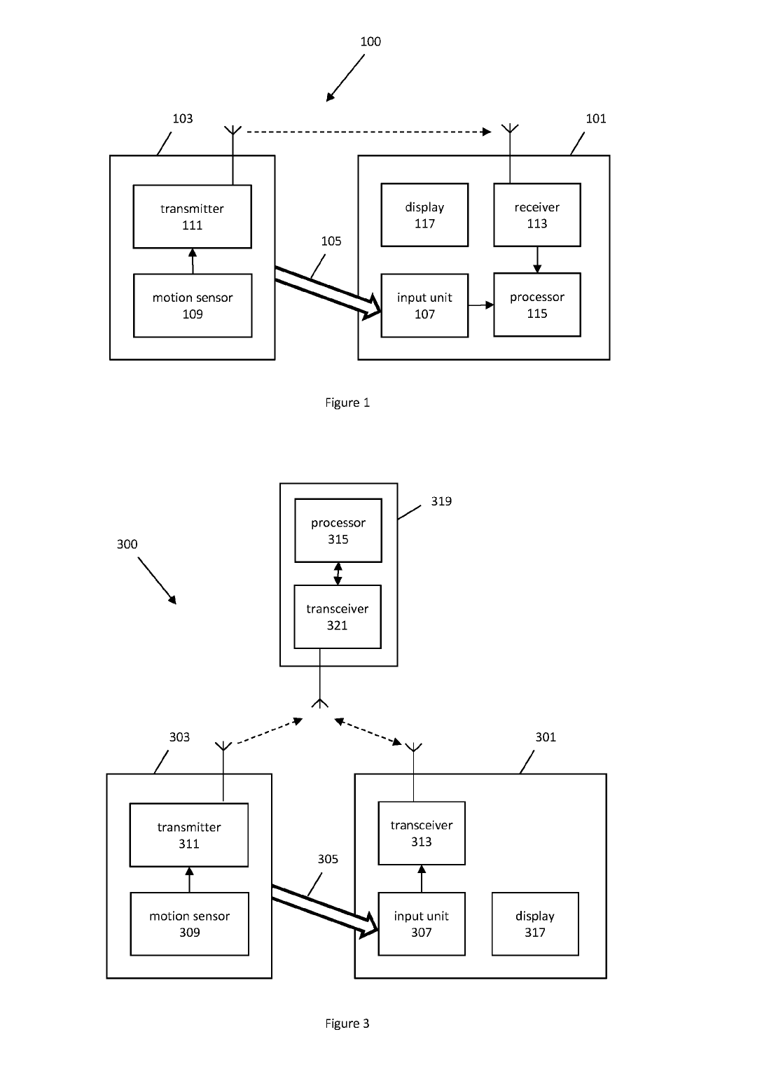

FIG. 1 illustrates a first exemplary system embodying the present invention. The system 100 comprises a device 101 (e.g. a user device) and a motion unit 103. As described in greater detail below, the device 101 is configured for receiving an input (e.g. a touch input or a proximity input) applied by a user, and the motion unit 103 is configured for measuring the motion of an input object 105 (e.g. finger or stylus) used to apply the input. By comparing (e.g. correlating) motion of the input detected by the device 101 with motion measured by the motion unit 103, it is possible to determine whether the input was applied using the input object 105. The motion of the input detected by the device 101 may comprise, for example, motion actually detected by the device 101, or motion that would be expected when applying an input of a certain type (e.g. drag or tap) detected by the device 101.

In certain exemplary embodiments described below, a touch or proximity input is used as an example of the input. However, the skilled person will appreciate that the present invention is not limited to these specific examples, and that an input may comprise any other suitable type of input. The embodiments described herein may be modified accordingly.

As illustrated in FIG. 1, the motion unit 103 comprises a motion sensor 109 for measuring motion of the motion unit 103, and a transmitter 111 for transmitting motion data generated by the motion sensor 109 to the device 101. The device 101 comprises a display 117 for displaying a user interface, an input unit 107 for receiving a touch or proximity input, a receiver 113 for receiving motion data from the motion unit 103, and a processor 115 for performing various operations of the device 101. For example, the processor compares the motion data received from the motion unit 103 with touch or proximity input data generated by the input unit 107 in order to determine whether an input applied to the input unit 107 was made by the input object 105. The processing performed by the processor 115 will be described in greater detail below. The device 101 and/or the motion unit 103 may additionally comprise a storage unit (not shown), for example for storing data (e.g. motion data and/or input data) used or generated during operation, and/or software (e.g. operating system or code) used to control various operations and processes.

The device 101 may comprise any suitable type of device configured for receiving a touch or proximity input, for example a portable terminal or handheld device (e.g. a mobile telephone, personal organiser, tablet computer and the like), a computer (e.g. a desktop computer, laptop computer and the like), or any other type of device configured to receive a touch or proximity input (e.g. a touch table, television, Automated Teller Machine (ATM), industrial or medical device control system interface, and the like).

The input unit 107 may comprise any suitable means for receiving a touch or proximity input. For example, the input unit 107 may comprise a touch panel or a touch screen. The input unit 107 may additionally or alternatively comprise one or more other types of sensor or input means for detecting a touch or proximity input, for example based on sound or images, or variations in a magnetic or electric field. A surface of the device (e.g. a surface of the input unit 107) that is used to receive or detect a touch input or a proximity input may be referred to as an input surface.

The touch or proximity input may comprise any suitable type of input or gesture. For example, a touch input may refer to an input or gesture in which an input object comes into direct physical contact with an input surface of the device 101. For example, a touch input may comprise a touch, double touch (or tuple touch), tap, short touch, long touch, and the like. A proximity input may refer to an input or gesture in which an input object is spaced apart from an input surface of the device, without direct physical contact between the input object and the input surface. For example, a proximity input may comprise an approach, retreat, hover, and the like. Certain inputs may be realised in the form of either a touch input or a proximity input depending on whether the input object is in direct physical contact with an input surface of the device 101 during the input. For example, these types of touch may include a drag, sweep, flick, trace, figurative trace, and the like. Certain types of input may comprise aspects of both a touch input and a proximity input, for example an input comprising an approach followed by a touch.

The input object 105 may comprise any suitable means for applying a touch or proximity input, for example a finger, hand or other body part of the user, a stylus, a pen, and the like.

The motion unit 103 is arranged, during use, to co-move with the input object 105. For example, the motion unit 103 may be attached to a body part of a user (e.g. the user's wrist or finger) or may be incorporated in the input object 105. Accordingly, when the user applies an input using the input object 105, the motion of the input object 105 used to apply the input may be measured by the motion unit 103. If the motion unit 103 is incorporated into the input object 105 (e.g. in the case of a stylus or pen), then the motion sensor may directly measure the motion of the input object 105. On the other hand, if the motion unit 103 is attached to a body part of the user, then the motion unit 103 indirectly measures the motion of the input object 105 by measuring the motion of the body part. In this case, it is preferable that the motion unit 103 is attached to the user during use such that the motion of the body part to which the motion unit 103 is attached corresponds closely to the motion of the input object 105. For example, the motion unit 103 may be incorporated into a ring worn on the user's finger (or any other suitable type of jewellery), incorporated into a thimble worn on the end of a finger, or attached to a band worn around the user's wrist. In certain embodiments, the motion unit may be incorporated into a “smart” device, for example a “smartwatch”, “smart-glasses”, and the like.

The motion sensor 109 may comprise any suitable type of sensor for measuring motion. For example, the motion sensor 109 may comprise one or more accelerometers and/or one or more gyroscopes for measuring acceleration (e.g. linear acceleration). In some exemplary embodiments, the motion sensor 109 may comprise a single three-axis accelerometer for measuring acceleration. In other exemplary embodiments, the motion sensor 109 may comprise a single three-axis accelerometer and a gyroscope for measuring linear acceleration. The accelerometers may be of any suitable type, for example a piezoelectric accelerometer, piezoresistive accelerometer, capacitive accelerometer, Micro Electro-Mechanical System (MEMS) accelerometer, and the like.

In certain embodiments, the motion sensor 109 may be configured for measuring motion with respect to one or more linearly independent (e.g. orthogonal) axis. For example, the motion sensor 109 may comprise one or more accelerometers and/or gyroscopes for measuring acceleration (e.g. linear acceleration) about one or more axis (e.g. X, Y and Z axis). Alternatively, or additionally, the motion unit 103 may be configured for measuring the acceleration magnitude, independent of direction. For example, the motion sensor 109 may comprise a sensor for directly measuring the acceleration magnitude, or the motion unit may comprise a processor (not shown) for computing the acceleration magnitude from the components of a measured acceleration vector.

The motion sensor 109 may generate motion data comprising, for example, a sequence of values indicating the motion (e.g. linear acceleration) of the motion unit 103 at certain (e.g. regular) time points. The values may be generated, for example, by sampling the measured motion at a certain frequency, for example 100 Hz. The resulting motion data may be expressed, for example, as a sequence of vector values and/or a sequence of magnitude values.

The transmitter 111 of the motion unit 103 and the receiver 113 of the device 101 may comprise any suitable means for forming a wired or wireless communication channel between the motion unit 103 and the device 101. For example, the communication channel may be formed based on any suitable communication technique, for example Near Field Communication (NFC), Bluetooth, WiFi, and the like. The transmitter 111 obtains the motion data from the motion sensor 109, and transmits the motion data in any suitable format to the device 101. The motion data may be transmitted together with identification information for identifying the particular motion unit 103 that has generated the motion data, for example an identification that is unique to the particular motion unit 103 that has generated the motion data. This allows the device 101 to identify which motion unit 103 has generated the motion data, and allows the device 101 to distinguish between motion data received from different motion units 103.

The processor 115 receives touch or proximity input data (referred to below simply as input data) from the input unit 107. The input data may comprise, for example, a sequence of values indicating the coordinates of a touch or proximity input at certain (e.g. regular) time points. The values may be generated, for example, by sampling the input coordinates at a certain frequency, for example 100 Hz. The input coordinates may be sampled at the same sampling frequency used by the motion sensor 109 to generate the motion data. The coordinates of an input may comprise, for example, X and Y coordinates defining a position of the input object 105 with respect to the plane of the input surface. In certain embodiments, the coordinates may also comprise a Z coordinate defining a spacing between the input object 105 and the input surface.

In certain embodiments, the processor 115 may perform various pre-processing on the input data received from the input unit 107, for example filtering, smoothing, averaging, and the like. In one example, the processor 115 filters the input data by applying an N-sample (e.g. N=2, 3, 4, 5, . . . ) moving average filter to smooth the data and remove noise.

Whether or not pre-processing is applied to the input data, if the input data comprises input coordinates, the processor differentiates the input data twice to obtain a sequence of values indicating the acceleration of the touch or proximity input at certain (e.g. regular) time points.

The acceleration values obtained from the input data may be expressed as vector values and/or as a magnitude. An acceleration magnitude may be obtained by computing the magnitude of a corresponding acceleration vector. Alternatively, after the first differentiation, the magnitude of each resulting velocity vector may be computed, and the velocity magnitudes may be differentiated in the second differentiation to obtain the acceleration magnitude values. As described below, acceleration magnitude values may be used in order to simplify processing and achieve orientation independence.

In certain embodiments, the input data may be processed after one or both of the differentiations. For example, the data may be filtered after each differentiation by applying an N-sample moving average filter.

In addition to receiving the input data from the input unit 107, the processor 115 also receives motion data from the motion unit 103 via the receiver 113. As described above, the motion data may comprise, for example, a sequence of acceleration values that may be expressed as vector values and/or as magnitude values. Depending on the form of the motion data received from the motion unit 103, the processor 115 may process the received motion data to convert the motion data to a different form suitable for further processing. For example, in certain embodiments, if the received motion data comprises acceleration data and gyroscope data, then the processor 115 may obtain or derive data representing linear acceleration from the received motion data. In another example, the processor may compute acceleration magnitude values from received acceleration vector values.

In certain embodiments, the processor 115 may perform various pre-processing on the motion data, or data obtained or derived from the motion data, for example filtering, smoothing, averaging, and the like. In one example, the processor 115 filters the motion data by applying an N-sample (e.g. N=2, 3, 4, 5, . . . ) moving average filter to smooth the data and remove noise.

The processor 115 compares the acceleration values obtained from the input data with the acceleration values obtained from the motion data to determine whether the touch or proximity input corresponding to the input data was applied using the input object whose motion corresponds to the motion data. For example, the comparison may be performed by correlating the acceleration values obtained from the input data with the acceleration values obtained from the motion data. The comparison or correlation may be performed based on acceleration vector values and/or acceleration magnitude values. In certain embodiments, by using acceleration vector values, greater accuracy may be achieved at the expense of increased complexity. On the other hand, in certain embodiments, by using acceleration magnitude values, complexity may be reduced at the expense of reduced accuracy.

In the case that the comparison is performed based on acceleration vector values, when performing the comparison, it may be necessary to take into account any difference in orientation between the motion unit 103 and the device 101. It may also be necessary to compensate a measured motion to take into account the effects of gravity. For example, an accelerometer measures acceleration relative to the orientation of the sensor along three perpendicular axis. This measurement is subject to a bias that results from the earth's gravitational field. In order to utilise the accelerometer to capture motion relative to a touch surface, for example for calculating a similarity of the movement to a touch gesture, this coordinate system may require transformation.

In a first example, the motion unit 103 and the device may each be configured to determine the direction of gravity with respect to their own respective internal coordinate systems. The motion unit 103 transmits its own determined gravity direction to the device 101. The device 101 then calculates a difference between the gravity direction received from the motion unit 103 with its own determined gravity direction to determine an orientation difference between the respective coordinate systems of the motion unit 103 and the device 101. This difference may then be used to compensate for the difference in orientations when performing the comparison.

The direction of gravity may be determined using any suitable technique, for example based on using a linear accelerometer to measure the linear acceleration direction during a calibration period when the motion unit 103 or device 101 is held at rest, and one or more gyroscopes to track subsequent changes in orientation of the motion unit 103 or device 101. The determined gravity direction may be used to compensate any measured motion, if necessary.

In a second example, the orientation of the motion unit 103 with respect to a touch surface of the device 101 may be estimated using Principle Component Analysis (PCA). In particular, when the user applies certain gestures to the touch surface (e.g. a drag gesture), the directions along which the motion unit 103 moves will tend to be constrained, as the user remains in contact with the touch surface during the gesture. Accordingly, the two main directions of acceleration experienced by the motion sensor 109 correspond approximately to the plane of the touch surface.

In this case, the transformation of the input unit (e.g. touch sensor) coordinates may be performed, for example, using dimensionality reduction techniques. Dimensionality reduction techniques are computational tools used to transform a coordinate system with d dimensions to a different coordinate system with d′ dimensions, for example according to a heuristic algorithm, or any other suitable technique. The transformed coordinate system may have a smaller dimensionality (i.e. d>d′), but retains some characteristics of the original coordinate system.

One such technique is PCA. According to this technique, a number of samples from an accelerometer may be used to estimate their principal components during one or more touch gestures. In PCA, these principal components are those directions, relative to the sensor, on which most of the measured variance occurs. The first two principal components lie approximately within the plane of the touch surface if estimated using samples recorded at the time the gesture is performed. These principal components may then be utilised to project the data captured over the course of the gesture, or smaller parts of it, into a coordinate system relative to the orientation of the device.

The skilled person will appreciate that, equivalently, the coordinate system of the motion unit 103, rather than the coordinate system of the input unit 107, may be transformed, or the coordinate systems of both the motion unit 103 and the input unit 107 may be transformed.

In a third example, the comparison between the motion data and the input data may be repeated a number of times, each time with a different orientation perturbation applied to one or both of the motion data and input data. The comparison producing the closest match may be used.

On the other hand, in the case that the comparison is performed based on acceleration magnitude values it may not be necessary to take into any difference in orientation between the motion unit 103 and the device 101. Accordingly, the comparison process may be made orientation independent.

In certain exemplary embodiments, comparison of the motion data and the input data may be performed by computing a correlating value based on acceleration magnitude values of the motion data and the input data. For example, a correlation value may be computed using Equation 1 below.

$${r}_{12} = \frac{Σ ( {d}_{1} - \overline{{d}_{1}} ) \cdot ( {d}_{2} - \overline{{d}_{2}} )}{\sqrt{{Σ ( {d}_{1} - \overline{{d}_{1}} )}^{2} \cdot {( {d}_{2} - \overline{{d}_{2}} )}^{2}}} \qquad ( Eq . 1 )$$

In Equation 1, d₁ denotes a sample of the linear acceleration magnitude obtained from the input data and d₂ denotes a sample of the linear acceleration magnitude obtained from the motion data. The summation is taken over a sequence of samples of a certain length, selected as appropriate (e.g. a fixed length, a length corresponding to a fixed period, or a length corresponding to one or more gestures, etc.). d̅₁̅ and d̅₂̅ denote the means of d₁ and d₂, respectively. The skilled person will appreciate that embodiments of the present invention are not limited to the Example of Equation 1, and that a correlation value may be computed in any other suitable way.

If the computed correlation value is higher than a certain threshold, then the processor 115 determines that the touch or proximity input corresponding to the input data was applied using the input object whose motion corresponds to the motion data. Accordingly, it is determined that the touch or proximity input was applied by the input object 105. On the other hand, if the computed correlation value is lower than or equal to the threshold, then the processor 115 determines that the touch or proximity input corresponding to the input data was not applied using the input object whose motion corresponds to the motion data. Accordingly, it is determined that the touch or proximity input was not applied by the input object 105.

In certain embodiments, if no motion data is received, or motion data is not properly received, by the device 101 (for example if the motion unit 103 is powered down or out of transmission range), then the processor 115 may determine (or assume) that the touch or proximity input corresponding to the input data was not applied by the input object.

In certain embodiments, the processor 115 may use the identification information received from the motion unit 103 to identify the motion unit 103 that generated the motion data, for example by comparing the received identification information with stored identification information.

The processor 115 may control processing of one or more inputs corresponding to the input data. For example, the processor 115 may control processing of the inputs (i) depending on a result of the determination as to whether or not the inputs were applied by the input object; and/or (ii) according to the identity of the motion unit 103 (and hence the identity of the input object) based on the received identification information. For example, the processor 115 may output a signal for controlling processing of the inputs. The signal for controlling processing of the inputs may comprise, for example, a signal authorising a restricted operation performed using the inputs.

In certain embodiments, the correlation may be computed in such a way so as to be magnitude independent. In this case, a relatively high energy gesture (e.g. involving relatively high accelerations), may correlate relatively highly to a relatively low energy noise signal. Accordingly, in certain embodiments, in addition to comparing the correlation value with a first threshold, the processor 115 may also compare the energy level of the motion indicated by the motion data and the energy level of the motion indicated by the input data. The energy level of motion may be computed based on, for example, a magnitude of the acceleration of the motion (e.g. mean acceleration or peak acceleration of the motion). The processor 115 may then determine that the touch or proximity input corresponding to the input data was applied using the input object whose motion corresponds to the motion data only if the difference (e.g. absolute difference or magnitude of difference) between the energy levels is lower than a certain second threshold.

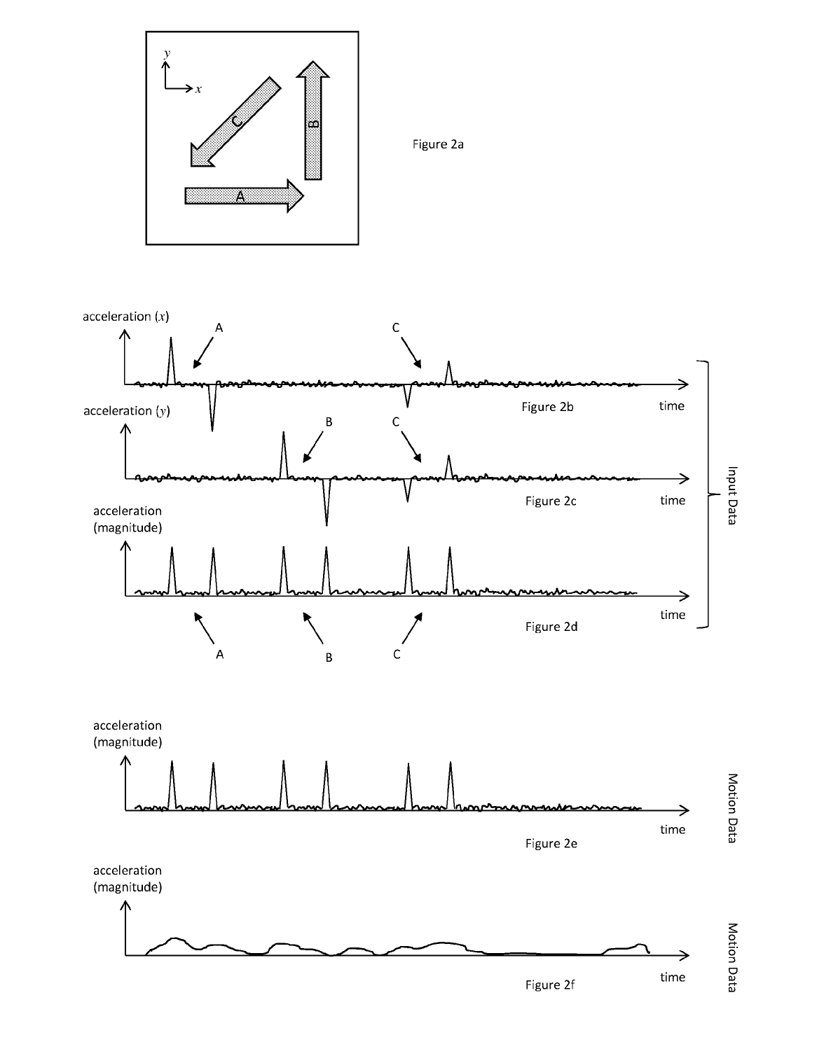

FIGS. 2a-f illustrate an example of an input applied by a user, the input data and motion data resulting from the input, and motion data unrelated to the input. As shown in FIG. 2a, a user inputs a sequence of three drag gestures, A, B and C, on a touch screen. The first drag gesture is a horizontal drag in the positive x-direction, the second drag gesture is a vertical drag in the positive y-direction, and the third drag gesture is a diagonal drag in the negative x and negative y directions.

FIGS. 2b and 2b illustrate the accelerations in the x and y directions, respectively, computed from the input data resulting from gestures A-C. FIGS. 2b and 2c show the occurrence of acceleration spikes corresponding to the start and end points of each gesture, and also the occurrence of periods of substantially zero acceleration in the middle of each gesture and between gestures. In particular, a single drag gesture may be characterised by an acceleration pattern comprising an acceleration spike of a particular sign occurring at the beginning of the drag, followed by a period of substantially zero acceleration in the middle of the drag, followed by an acceleration spike of opposite sign at the end of the drag.

No acceleration spikes occur in the x-direction as a result of gesture B, which occurs in the y-direction only. Similarly, no acceleration spikes occur in the y-direction as a result of gesture A, which occurs in the x-direction only. The acceleration spikes in the x and y directions occurring as a result of gesture C are smaller than the acceleration spikes occurring as a result of gestures A and B since gesture C is diagonal.

FIG. 2d illustrates the acceleration magnitude obtained from the input data generated by the input unit 107 resulting from the inputting of gestures A-C to the input unit 107. In other words, the graph of FIG. 2d represents the motion used to apply the input, as measured by the input unit 107. In contrast to the accelerations in the x-direction and y-direction, each of the gestures A-C results in a similar pattern of acceleration magnitude.

FIG. 2e illustrates the acceleration magnitude obtained from the motion data generated by the motion unit 103 associated with the input object 105 used to apply the gestures A-C. In other words, the graph of FIG. 2e represents the motion used to apply the input, as measured by the motion unit 103.

The pattern of acceleration obtained from the motion data illustrated in FIG. 2e is similar to the pattern of acceleration obtained from the input data illustrated in FIG. 2d. Therefore, the correlation between these acceleration patterns, for example as measured by a correlation value computed according to Equation 1 above, will be relatively high. Hence, it may be determined that the user of the motion unit 103 applied the input gestures A-C.

FIG. 2f illustrates the acceleration magnitude obtained from motion data generated by another motion unit that is not associated with the input object 105 used to apply the gestures A-C. In other words, the graph of FIG. 2f represents motion, as measured by the other motion unit, which is not associated with applying the input. For example, the other motion unit may be worn by a user who is not currently using the device 101. The other motion unit may be of the same or similar form as the motion unit 103, and may generate and transmit motion data that is received by the device 101.

The pattern of acceleration obtained from the motion data illustrated in FIG. 2f is significantly different from the pattern of acceleration obtained from the input data illustrated in FIG. 2d. Therefore, the correlation between these acceleration patterns, for example as measured by a correlation value computed according to Equation 1 above, will be relatively low. Hence, it may be determined that the user of the other motion unit did not apply the input gestures A-C.

The skilled person will appreciate that embodiments of the present invention are not limited to using correlation as a form of comparison. For example, different types of input gesture may be characterised by different motion (e.g. acceleration) patterns. A drag gesture may result in an acceleration pattern illustrated in FIGS. 2b-e, while other types of input gesture may be characterised by acceleration patterns having a different form. For example, a single flick gesture may be characterised by an acceleration pattern comprising only a single acceleration spike. As another example, a tap gesture may be characterised by an acceleration pattern comprising acceleration in the z-direction only.

In certain embodiments, the input unit may be configured to detect certain types of gesture (e.g. drag, flick, tap, multi-tap etc.). Upon detecting a gesture, the input unit may generate input data comprising an indication of the type of the gesture, one or more parameters defining characteristic of the gesture, and/or a time stamp indicating the time of the gesture. The parameters defining characteristics of the gesture may comprise, for example, gesture start and/or end positions (e.g. in the case of a drag or flick), gesture speed (e.g. in the case of a drag or flick), repetition frequency (e.g. in the case of a multi-tap), and the like. Upon receiving the input data, the processor 115 may determine a motion (e.g. motion pattern) that is associated with a particular type of input or gesture indicated by the input data is input (e.g. a typical or expected motion used when applying the type of input or gesture), for example using information associating different types of gesture with respective motion patterns stored in a storage unit. The processor 115 may then perform a comparison between the typical motion and motion indicated by the motion data received from the motion unit.

In certain exemplary embodiments of the present invention, the process of comparing the acceleration values obtained from the input data with the acceleration values obtained from the motion data may comprise identifying and/or comparing acceleration patterns, without necessarily performing a correlation.

FIG. 3 illustrates a second exemplary system embodying the present invention. The system of FIG. 3 is similar to the system of FIG. 1, except that at least some of the functions performed by the processor 115 of the device 101 in the system of FIG. 1 are performed by a separate server 319 in the system of FIG. 3. As illustrated in FIG. 3, the server 319 comprises a processor 315 that performs similar functions to the processor 115 described above in relation to FIG. 1. The server 319 also comprises a transceiver 321 for communicating with a motion unit 303 and a device 301. The device 301 comprises a transceiver 313 for two-way communication with the server 319.

In the system of FIG. 3, the motion unit 303 measures motion using a motion sensor 309 and transmits motion data to the server 319 using a transmitter 311. The motion unit 303 may also transmit identification information for identifying the motion unit 303 to the server 319 using the transmitter 311. The device 301 generates input data as a result of a touch or proximity input applied to an input unit 307, which is transmitted to the server 319 using the transceiver 313. The device 301 may also transmit identification information for identifying the device 301 to the server 319 using the transceiver 313. The server 319 receives the motion data and the input data, obtains acceleration values from each of the motion data and the input data, and compares (e.g. correlates) the acceleration values obtained from the motion data and the input data, in a manner described above in relation to FIG. 1.

The server 319 may also determine the identity of the motion unit 303 and/or the identity of the device 301 using respective pieces of received identification information, for example by comparing the received identification information with stored identification information.

The server 319 then transmits a result signal to the device 301, the result signal depending on (i) a result of the comparison between the acceleration values obtained from the motion data and the input data, and/or (ii) the identity of the motion unit 301 and/or the identity of the device 301. The device 301 may process the touch or proximity input applied to the input unit 307 differently according to the result signal. For example, the result signal may comprise a signal authorising a restricted operation performed using the inputs.

In the various embodiments described herein, the motion data may be transmitted together with identification information for identifying the particular motion unit 103 that has generated the motion data, for example an identification that is unique to the motion unit, to allow motion data generated by different motion units to be distinguished. Similarly, the input data may be transmitted together with identification information for identifying the particular device that has generated the input data, for example an identification that is unique to the device, to allow input data generated by different devices to be distinguished.

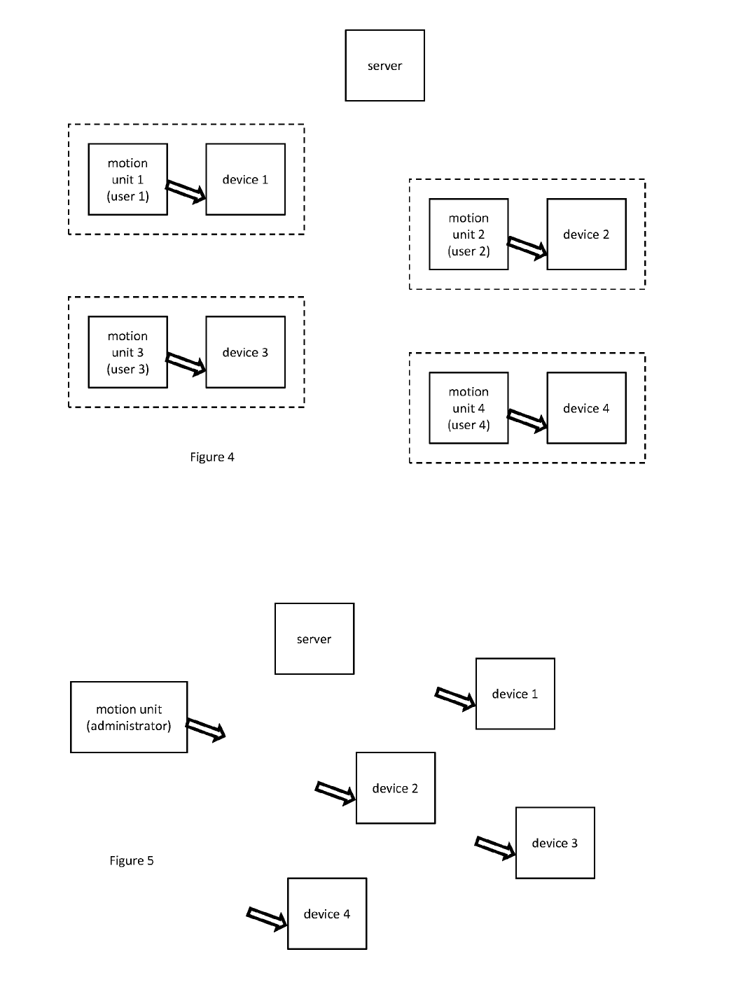

FIG. 4 illustrates a third exemplary system embodying the present invention. The system of FIG. 4 is similar to the system of FIG. 3 except that multiple motion units and multiple devices are shown. In this embodiment, each device is paired with a respective motion unit, and each motion unit is worn by a respective user. The server continuously monitors motion data transmitted by each of the motion units and input data transmitted by each of the devices. The server distinguishes between motion data received from different motion units and input data received from different devices, for example by the identification information transmitted with the motion data and the input data.

The system of FIG. 4 may be configured such that a certain device is only allowed to be operated if a certain set of inputs are applied to that device by a user wearing the corresponding motion unit, in response to a challenge issued by the server. Various examples of challenges are described further below. Thus, according to this scheme, user 1 is allowed to operate device 1 and user 2 is allowed to operate device 2, but user 1 is not allowed to operate device 2.

When an input is applied to device 1 by user 1, the server determines that the correlation between the acceleration measured by motion unit 1 (worn by user 1) and the acceleration of the input applied to device 1 (by user 1) is relatively high. Accordingly, the server determines that the input applied to device 1 is made by user 1, and therefore operation of device 1 (by user 1) is allowed.

Similarly, when an input is applied to device 2 by user 2, the server determines that the correlation between the acceleration measured by motion unit 2 (worn by user 2) and the acceleration of the input applied to device 2 (by user 2) is relatively high. Accordingly, the server determines that the input applied to device 2 is made by user 2, and therefore operation of device 2 (by user 2) is allowed.

However, when an input is applied to device 2 by user 1, the server determines that the correlation between the acceleration measured by motion unit 2 (worn by user 2) and the acceleration of the input applied to device 2 (by user 1) is relatively low. Accordingly, the server determines that the input applied to device 2 is not made by user 2. The server determines that the correlation between the acceleration measured by motion unit 1 (worn by user 1) and the acceleration of the input applied to device 2 (by user 1) is relatively high. Accordingly, the server determines that the input applied to device 2 is made by user 1, and therefore operation of device (by user 1) is not allowed.

FIG. 5 illustrates a fourth exemplary system embodying the present invention. In this embodiment, the system comprises multiple devices and a single motion unit. The system is configured such that certain restricted device operations are only allowed to be performed by an authorised user (e.g. an administrator) who is wearing the motion unit.

This type of system may be applied, for example, in a classroom scenario in which each student uses a respective device, and a teacher, who may also have their own device, may wish to move around the classroom to supervise the students. In this scenario it is desirable to allow the teacher to access certain restricted commands not available to the students. For example, the teacher may wish to issue global commands affecting all devices in the classroom (e.g. freeze or unfreeze all devices), perform certain operations on a specific device (e.g. override certain progress conditions), project the contents of a specific device to a public display, or enable content to be transferred between devices.

Accordingly, the teacher wears the motion unit, which provides access to restricted operations. Specifically, when a user attempts to perform a restricted operation using a particular device, the device transmits a signal to the server requesting a challenge. In response, the server generates a challenge and transmits the challenge back to the device. The challenge prompts the user to apply a certain set of one or more inputs using the device. The device transmits input data to the server and the motion unit transmits motion data to the server. The server compares the motion data and the input data, for example in a manner described above, and transmits a result signal to the device depending on a result of the comparison. For example, a result signal authorising the device to perform the restricted operation may be transmitted only if a correlation value computed based on the motion data and the input data is sufficiently high. Thus, the restricted operation is only allowed if the inputs prompted by the challenge are applied by the user who is wearing the motion unit (i.e. the teacher). A result signal authorising the device to perform the restricted operation may be transmitted by the server only if the server determines the identity of the motion unit as an authorised motion unit. Thus, the restricted operation is only allowed if the inputs prompted by the challenge are applied by the user who is wearing a certain authorised motion unit (i.e. the teacher).

In more detail, when any user attempts to perform a non-restricted operation on a device, since the operation is non-restricted, the operation is allowed. However, when a user attempts to perform a restricted operation on a certain device (e.g. device 1), the server determines whether or not a certain input applied to device 1 (e.g. in response to a challenge issued by the server) is made by the authorised user who is wearing the motion unit. Specifically, when an input is applied to device 1 by the authorised user, the server determines that the correlation between the acceleration measured by the motion unit (worn by the authorised user) and the acceleration of the input applied to device 1 is relatively high. Accordingly, the server determines that the input applied to device 1 is made by the authorised user, and therefore transmits a result signal to device 1 indicating that the operation is allowed, thereby authorising the restricted operation

On the other hand, when an input is applied to device 1 by another user who is not wearing the motion unit, the server determines that the correlation between the acceleration measured by the motion unit (worn by the authorised user, and not by the user who is applying the input) and the acceleration of the input applied to device 1 is relatively low. Accordingly, the server determines that the input applied to device 1 is not made by the authorised user, and therefore transmits a result signal to device 1 indicating that the operation is not allowed, thereby denying the restricted operation.

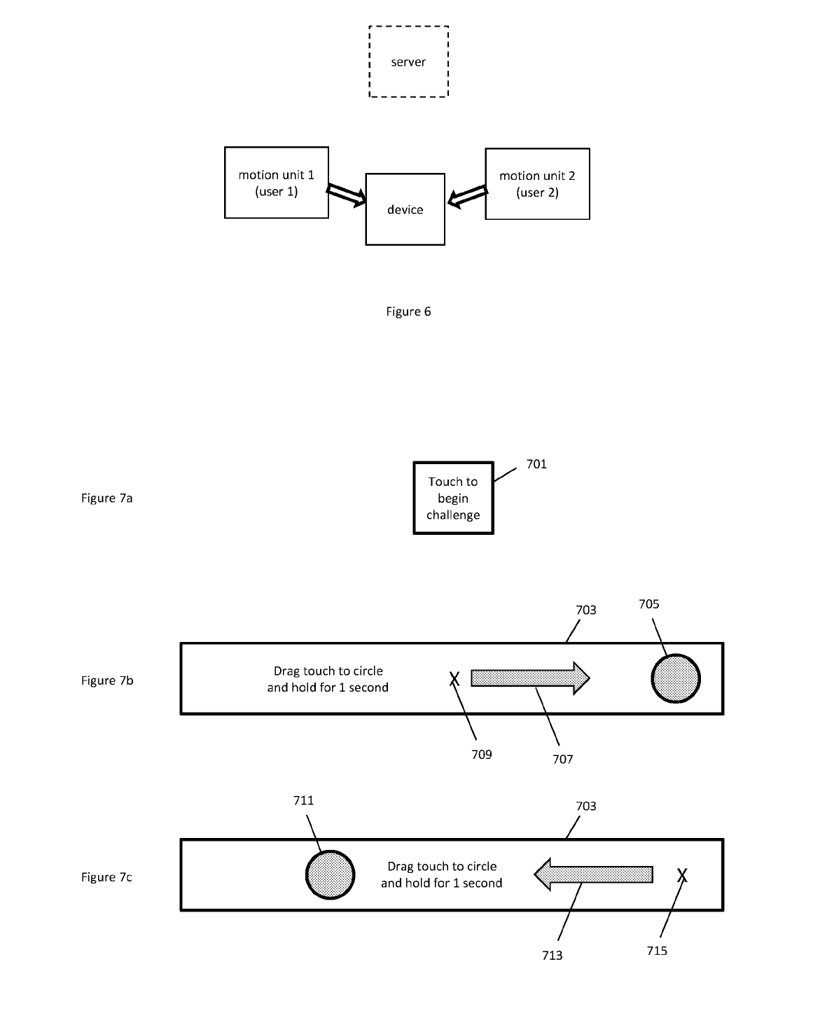

FIG. 6 illustrates a fifth exemplary system embodying the present invention. In this embodiment, the system comprises a device and two motion units, each worn by a respective user. The system may optionally comprise a server. This configuration allows two users to interact simultaneously with the same device. Specifically, when user 1 applies a first input to the device and the second user applies a second input to the device, the device or the server may determine that (i) the correlation between the acceleration measured by motion unit 1 (worn by the user 1) and the acceleration of the first input applied to the device is relatively high, and (ii) the correlation between the acceleration measured by motion unit 2 (worn by the user 2) and the acceleration of the second input applied to the device is relatively high.

Additionally, or alternatively, the device or the server may determine that (i) the correlation between the acceleration measured by motion unit 1 (worn by the user 1) and the acceleration of the first input applied to the device is higher than the correlation between the acceleration measured by motion unit 1 (worn by the user 1) and the acceleration of the second input applied to the device, and (ii) the correlation between the acceleration measured by motion unit 2 (worn by the user 2) and the acceleration of the second input applied to the device is higher than the correlation between the acceleration measured by motion unit 2 (worn by the user 2) and the acceleration of the first input applied to the device. In other words, the device or server may determine which motion unit acceleration correlates more with each input.

The server may distinguish between accelerations measured by different motion units based on identification information transmitted by each motion unit.

Accordingly, the device or the server determines that the first input applied to the device is made by user 1 and the second input applied to the device is made by user 2.

In certain embodiments, for example one or more of the embodiments described above, in order to authenticate the user of a device, the user may be issued with a challenge which prompts the user to apply a set of one or more inputs. In order to be authenticated, the user must successfully complete the challenge by inputting the set of inputs whilst wearing a certain motion unit. When authentication of a user is required, a server, or other trusted or secure entity, generates a challenge, which is transmitted to the user's device. In certain embodiments, to increase security, a different challenge may be generated each time authentication is required, and/or the challenge must be successfully completed within a certain time. In embodiments that do not comprise a server, for example the embodiment illustrated in FIG. 1, the challenge may be generated and/or assessed by a secure region of the device 101, for example components and/or software protected by one or more security features to prevent hacking and/or tampering.

FIGS. 7a-c illustrates a first example of a challenge. As illustrated in FIG. 7a, initially, a button 701 is displayed on a user interface. When a user touches the button, the button 701 expands to show a slider 703 on which a first indicator 705 is displayed at a first position, as illustrated in FIG. 7b. For example, the first indicator 705 may be in the form of a coloured circle. The user is then required to perform a first drag gesture 707 to move the touch position 709 to the position of the first indicator 705 and hold the touch at that position for a certain amount of time (e.g. 1 second). If this task is performed correctly, then the first indicator 705 disappears and a second indicator 711 is displayed at a second position, as illustrated in FIG. 7c. The user is then required to perform a second drag gesture 713 to move the touch position 715 to the position of the second indicator 711 and hold the touch at that position for a certain amount of time (e.g. 1 second). The above process is repeated a certain number of times, and if the user performs all drag and hold gestures correctly, then the user is deemed to have successfully completed the challenge.

However, for successful authentication, it is also necessary to verify that it is the user to be authenticated, rather than another user, who has completed the challenge. Accordingly, the server correlates input data received from the device on which the challenge is conducted with motion data from the motion unit worn by the user to be authenticated, and if the level of correlation is greater than a certain threshold then the user is authenticated. The motion data of the user to be authenticated may be distinguished from motion data of other users using the identification information transmitted with the motion data. The input data of the device on which the challenge is conducted may be distinguished from input data of other devices using the identification information transmitted with the input data.

In certain embodiments, the server may also determine or verify the identity of the motion unit worn by the user to be authenticated based on identification information transmitted by the motion unit. For example, the user may be authenticated only if the identity of the motion unit is successfully verified, for example as a certain authorised motion unit.

In the challenge procedure described above, in order to achieve a relatively high reliability, a relatively distinct set of inputs may be required. For example, in the case that acceleration magnitude values are used, there may be a significant probability that random movement of a motion unit will correlate to any individual touch or proximity input. By introducing a sequence of gestures, and by introducing required periods of inactivity (e.g. hold) in between the gestures (e.g. drag) in a challenge, the probability that random or casual movement of a motion unit will result in successful authentication from the challenge is reduced. Accordingly, the reliability of the challenge may be increased.

The skilled person will appreciate that embodiments of the present invention are not limited to the challenge illustrated in FIGS. 7a-c, and that any other suitable challenge may be used. For example, an alternative challenge may require the user to input a sequence of inputs in a certain pattern, for example a triangular sequence of drag gestures, as illustrated in FIG. 2a.

Furthermore, the challenge is not limited to drag gestures, but may comprise any type of gesture in which motion detected by a motion unit can be compared to an input detected by an input unit.

For example, in an alternative challenge, the user is prompted to input a sequence of taps at particular times, or in a particular rhythm. For example, a flashing indicator may be displayed, or a sound may be output, to indicate to the user when to input the taps, or in what rhythm the taps should be made. A motion unit worn by the user can detect the acceleration (e.g. acceleration in the z-direction) resulting from the action of the user inputting the sequence of tapping gestures to produce an acceleration pattern comprising a corresponding sequence of acceleration spikes. Similarly, the input unit can detect the sequence of tap gestures to obtain a pattern of taps. The challenge may be determined as successfully completed if the pattern of acceleration spikes obtained from the motion data is sufficiently similar to the pattern of tap gestures obtained from the input data.

In certain embodiments, a user may be authenticated by issuing a challenge prompting the user to input a certain set of one or more inputs. However, in some embodiments, authentication of a user may be performed on a continual basis. For example, a comparison (e.g. correlation) may be continuously performed between input data and motion data based on input data and motion data collected during a rolling window of certain duration (e.g. 1 minute), or a duration based on a certain period of active input (e.g. 20 seconds). If the correlation falls below a certain threshold, then the user may be prevented from operating a device, or may be required to successfully complete a challenge to continue normal operation. Since user inputs during normal use may be less distinct that inputs in a challenge, the threshold for continuous authentication may be less than the threshold used for a challenge.

In various exemplary embodiments, authenticating a user may be performed as on-going process or a repeated process, or may be performed as a temporary process or a one-time process. For example, in some exemplary embodiments, a user may be authenticated on a continuous basis for a certain period of time (e.g. 5 minutes). If the user remains authenticated during this time, then the system may stop performing the continuous authentication procedure, but regard the user as remaining authenticated, for example for the duration of a “session of activity” (e.g. a certain period of time, until the user is logged off or a device is locked, and/or until user activity stops for a certain period of time). Similarly, a user may be regarded as being authenticated for a session of activity by being authenticated using a challenge. A new session of activity may require the user to be re-authenticated.

The skilled person will appreciate that the present invention may be applied to any situation in which motion detected by a motion unit as a result of any type of user input may be compared with the input as detected by an input unit. For example, the motion detected by the motion unit may be compared with (i) motion detected from input data generated by the input unit, and/or (ii) typical or expected motion when applying a certain type of input detected by the input unit. For example, the present invention is not limited to inputs in the form of touch and proximity inputs, but may be applied to inputs applied using a physical actuation (e.g. using a physical button, key, switch, and the like). For example, when a press of a physical button is detected as an input, an acceleration detected by the motion unit when the button is pressed may be compared to typical motion expected when a user presses a physical button.

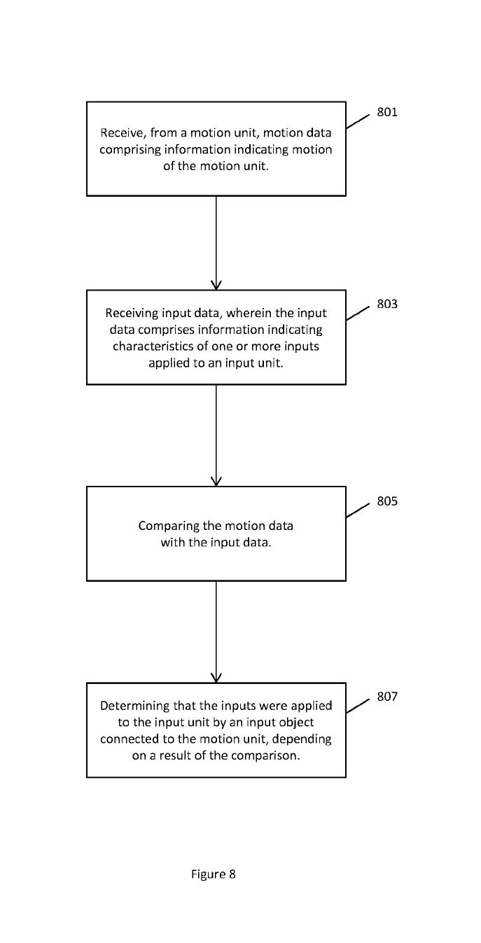

FIG. 8 illustrates a method according to an exemplary embodiment of the present invention. In a first step 801, motion data is received from a motion unit, the motion data comprising information indicating motion of the motion unit. In a next step 803, input data is received, wherein the input data comprises information indicating characteristics of one or more inputs applied to an input unit. In a next step 805, the motion data is compared with the input data. In a next step 807, it is determined that the inputs were applied to the input unit by an input object connected (i.e. directly or indirectly physically connected) to the motion unit, depending on a result of the comparison.

It will be appreciated that embodiments of the present invention can be realized in the form of hardware, software or a combination of hardware and software. Any such software may be stored in the form of volatile or non-volatile storage, for example a storage device, ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the invention has been shown and described with reference to certain embodiments thereof, it will be understood by those skilled in the art that various changes in form and detail may be made therein without departing from the scope of the invention as defined by the appended claims.

1. A method for processing an input applied by an input object, the method comprising the steps of:
receiving, from a motion unit, motion data comprising information indicating motion of the motion unit, wherein the motion unit is arranged to co-move with the input object;
receiving, from the motion unit, identification information for identifying the motion unit;
receiving input data, wherein the input data comprises information indicating characteristics of one or more inputs applied to an input unit;
comparing the motion data with the input data; and
outputting a signal for controlling processing of the inputs depending on a result of the comparison, and according to the identification information.

2. A method according to claim 1, wherein the signal for controlling processing of the inputs comprises a signal authorising a restricted operation performed using the inputs.

3. A method according to claim 1 or 2, wherein the motion data comprises information indicating acceleration of the motion unit measured by one or more accelerometers and/or one or more gyroscopes comprised in the motion unit.

4. A method according to claim 3, comprising the further step of computing a magnitude of the linear acceleration of the motion unit from the motion data.

5. A method according to any preceding claim, wherein the characteristics of the inputs comprise one or more of: (i) the coordinates, (ii) the velocity, (iii) the acceleration, (iv) the type, (v) one or more characteristics of the type, and (vi) a time stamp, of the inputs.

6. A method according to claim 5, wherein, when the characteristics inputs comprise the coordinates or the velocity of the inputs, the method comprises the further step of computing the acceleration of the inputs from the coordinates or the velocity of the inputs.

7. A method according to any preceding claim, wherein the step of comparing the motion data with the input data comprises the step of correlating the motion data with the input data.

8. A method according to claim 7, wherein the step of correlating the motion data with the input data comprises computing a correlation value.

9. A method according to claim 8, wherein the correlation value is computed according to Equation 1:
$${r}_{12} = \frac{Σ ( {d}_{1} - \overline{{d}_{1}} ) \cdot ( {d}_{2} - \overline{{d}_{2}} )}{\sqrt{{Σ ( {d}_{1} - \overline{{d}_{1}} )}^{2} \cdot {( {d}_{2} - \overline{{d}_{2}} )}^{2}}} \qquad ( Eq . 1 )$$
wherein d₁ denotes a sample of linear acceleration magnitude obtained from the input data and d₂ denotes a sample of linear acceleration magnitude obtained from the motion data.

10. A method according to claim 8 or 9, wherein the step of outputting the signal for controlling processing of the inputs depending on the result of the comparison comprises the step of determining that the correlation value exceeds a threshold.

11. A method according to any preceding claim, comprising the further step of pre-processing one or both of the motion data and the input data.

12. A method according to claim 11, wherein the pre-processing comprises filtering.

13. A method according to any preceding claim, comprising the further steps of:
generating a challenge for prompting the user to apply a certain set of one or more inputs; and
transmitting the challenge to a user device.

14. A method according to claim 13, wherein the step of receiving input data comprises receiving challenge response data from the user device, the challenge response data comprising input data corresponding to the certain set of one or more inputs applied by the user.

15. A method according to any preceding claim, comprising the further step of receiving the challenge for prompting the user to apply a certain set of one or more inputs.

16. A method according to any preceding claim, comprising the further step of outputting an authorisation signal when it has been determining that the inputs were applied to the input unit by the user.

17. A method according to any preceding claim, wherein the step of comparing the motion data with the input data comprises the step of comparing the motion data with motion associated with a type of input indicated by the input data.

18. A method according to any preceding claim, wherein the inputs comprise one or more of: a touch input; a proximity input; and an input using a physical actuation.

19. An apparatus for processing an input applied by an input object, the apparatus comprising:
a receiver for receiving, from a motion unit, motion data comprising information indicating motion of the motion unit, for receiving, from the motion unit, identification information for identifying the motion unit, and for receiving input data, wherein the motion unit is arranged to co-move with the input object, wherein the input data is based on the output of an input unit, and wherein the input data comprises information indicating characteristics of one or more inputs applied to the input unit; and
a processor for comparing the motion data with the input data, for outputting a signal for controlling processing of the inputs depending on a result of the comparison, and according to the identification information.

20. A method according to claim 19, wherein the signal for controlling processing of the inputs comprises a signal authorising a restricted operation performed using the inputs.

21. An apparatus according to claim 20, wherein the motion data comprises information indicating acceleration of the motion unit measured by one or more accelerometers and/or one or more gyroscopes comprised in the motion unit.

22. An apparatus according to claim 21, wherein the processor is configured for computing a magnitude of the linear acceleration of the motion unit from the motion data.

23. An apparatus according to any of claims 19 to 22, wherein the characteristics of the inputs comprise one or more of: (i) the coordinates, (ii) the velocity, (iii) the acceleration, (iv) the type, (v) one or more characteristics of the type, and (vi) a time stamp, of the inputs.

24. An apparatus according to claim 23, wherein, when the characteristics inputs comprise the coordinates or the velocity of the inputs, the processor is configured for computing the acceleration of the inputs from the coordinates or the velocity of the inputs.

25. An apparatus according to any of claims 19 to 24, wherein the processor is configured for comparing the motion data with the input data by correlating the motion data with the input data.

26. An apparatus according to claim 25, wherein the processor is configured for correlating the motion data with the input data by computing a correlation value.

27. An apparatus according to claim 26, wherein the correlation value is computed according to Equation 1:
$${r}_{12} = \frac{Σ ( {d}_{1} - \overline{{d}_{1}} ) \cdot ( {d}_{2} - \overline{{d}_{2}} )}{\sqrt{{Σ ( {d}_{1} - \overline{{d}_{1}} )}^{2} \cdot {( {d}_{2} - \overline{{d}_{2}} )}^{2}}} \qquad ( Eq . 1 )$$
wherein d₁ denotes a sample of linear acceleration magnitude obtained from the input data and d₂ denotes a sample of linear acceleration magnitude obtained from the motion data.

28. An apparatus according to claim 26 or 27, wherein the processor is configured for outputting the signal for controlling processing of the inputs depending on the result of the comparison by determining that the correlation value exceeds a threshold.

29. An apparatus according to any of claims 19 to 28, wherein the processor is configured for pre-processing one or both of the motion data and the input data.

30. An apparatus according to claim 29, wherein the pre-processing comprises filtering.

31. An apparatus according to any of claims 19 to 30, wherein the processor is configured for outputting an authorisation signal when it has been determining that the inputs were applied to the input unit by the user.

32. An apparatus according to any of claims 19 to 31, wherein the processor is configured for comparing the motion data with the input data by comparing the motion data with motion associated with a type of input indicated by the input data.

33. An apparatus according to any of claims 19 to 32, wherein the inputs comprise one or more of: a touch input; a proximity input; and an input using a physical actuation.

34. An apparatus according to any of claims 19 to 33, wherein the processor is configured for generating a challenge for prompting the user to apply a certain set of one or more inputs; and wherein the apparatus comprises a transmitter for transmitting the challenge to a user device.

35. An apparatus according to claim 34, wherein the receiver is configured for receiving challenge response data from the user device, the challenge response data comprising input data corresponding to the certain set of one or more inputs applied by the user.

36. A user device comprising an apparatus according to any of claims 19 to 33, and further comprising the input unit.

37. A server comprising an apparatus according to any of claims 19 to 35.

38. A system comprising:
an apparatus according to any of claims 19 to 35; and
the motion unit, wherein the motion unit comprises a motion sensor for measuring motion of the motion unit, and a transmitter for transmitting the motion data and the identification information, wherein the motion data is generated by the motion unit based on the measured motion of the motion unit.

39. A system according to claim 38, further comprising a user device, the user device comprising:
the input unit for receiving the input; and
a transmitter for transmitting the input data, wherein the input data is generated by the user device based on the input applied to the input unit.

40. An apparatus comprising: a receiver for receiving a challenge for prompting a user to apply a certain set of one or more inputs; an input unit for receiving one or more inputs applied by the user; and a transmitter for transmitting challenge response data, the challenge response data comprising input data corresponding to the certain set of one or more inputs applied by the user, wherein the input data comprises information indicating characteristics of one or more inputs applied to the input unit.

41. A method, apparatus, user device, server and/or system substantially as herein described and/or illustrated in the figures.
